(19) United States
(12) Patent Application Publication
(10) Pub. No.: US 2024/0133391 A1
(43) Pub. Date: Apr. 25, 2024

(54) PREDICTION METHOD FOR STALL AND SURGING OF AXIAL-FLOW COMPRESSOR BASED ON DEEP AUTOREGRESSIVE NETWORK

(71) Applicant: DALIAN UNIVERSITY OF TECHNOLOGY, Dalian, Liaoning (CN)

(72) Inventors: Yingshun LI, Dalian, Liaoning (CN); Ziqin GONG, Dalian, Liaoning (CN); Ximing SUN, Dalian, Liaoning (CN); Fuyang QUAN, Dalian, Liaoning (CN)

(21) Appl. No.: 18/014,573

(22) PCT Filed: Feb. 22, 2022
(86) PCT No.: PCT/CN2022/077168

§ 371 Date: Jan. 5, 2023

(51) Int. Cl. F04D 27/00; G06N 3/047

(52) U.S. Cl. CPC F04D 27/001; G06N 3/047

(57) ABSTRACT

The present invention provides a prediction method for stall and surging of an axial-flow compressor based on a deep autoregressive network. Firstly, selecting and preprocessing surging experimental data of a certain type of aero-engine, and dividing the data into a training set and a test set. Secondly, building and training a deep autoregressive network model based on an attention mechanism, using the finally trained model to conduct real-time prediction on the test set, and giving a model loss and an evaluation index. Finally, using a prediction model to conduct real-time prediction on the test data, and giving a trend of surging probability varying with time in chronological order. The present invention uses the attention mechanism to effectively capture the features of the experimental data and accurately predict the surging probability, which improve the stability and accuracy of prediction, is beneficial to improving the performance of active control of the engine.

### TECHNICAL FIELD

The present invention relates to a prediction method for stall and surging of an axial-flow compressor based on a deep autoregressive network of an attention mechanism, and belongs to the technical field of aero-engine modeling and simulation.

### BACKGROUND

Aero-engine is “a pearl in the crown” of human industrial history, which reflects the highest level of science and technology of a country. A compressor is a key component of a high performance aero-engine, which increases the air pressure through high-speed rotation of blades and provides a high pressure ratio while also limiting the stable operating range of the engine. The compressor plays an important role in the stability and safety of the aero-engine. Surging and rotating stall are two important manifestations for the fault of compressor airflow instability.

A main characteristic of compressor surging is to cause a phenomenon of airflow interruption, therefore the airflow will oscillate along the axis of the compressor with a low frequency (several hertz or tens of hertz) and a high amplitude, and flow obstruction or even reverse flow will occur in severe cases. Once occurs, surging will cause very serious damage to the aero-engine. Rotating stall is an unsteady flow phenomenon, which can significantly reduce the performance of the aero-engine. A large number of studies have shown that rotating stall is a surging inception, and surging is a result of extreme development of rotating stall. Therefore, rapid and accurate prediction of rotating stall has become an urgent problem to be solved in aero-engine field.

At present, two methods for detecting and discriminating a compressor rotating stall fault are adopted at home and abroad: the first method is to control the compressor actively by building a model, and inhibit compressor disturbance from going on when the compressor has a surging inception, thus to prevent the compressor from entering surging state. The second method is to research surging prediction algorithms based on time domain features or frequency domain features of pressure signals of the compressor. Among which, the traditional algorithms based on the time domain features of the pressure signals mainly include: a short-time energy method, an autocorrelation function method, a variance analysis method, a change rate method, a differential pressure method, a statistical characteristics method, etc.; and the traditional surging detection algorithms based on the time domain features of the pressure signals mainly include: a frequency spectrum analysing method, a wavelet analysis method, a frequency domain amplitude method, etc.

### SUMMARY

In view of the problems of low accuracy and poor reliability in the prior art, the present invention provides a prediction method for stall and surging of an axial-flow compressor based on a deep autoregressive network of an attention mechanism (i.e., a Temporal Pattern Attention Deep Auto regressive Recurrent Network (TPA-DeepAR)).

To achieve the above purpose, the present invention adopts the following technical solution:

A prediction method for stall and surging of an axial-flow compressor based on a deep autoregressive network, specifically a prediction method for stall and surging of an axial-flow compressor based on a deep autoregressive network of an attention mechanism, comprising the following steps:
S1. Preprocessing surging data of an aero-engine, comprising the following steps:
S1.1. Acquiring surging experimental data of a certain type of aero-engine, and eliminating invalid data produced by sensor fault from the experimental data;
S1.2. Downsampling and filtering the remaining valid data in sequence;
S1.3. Normalizing and smoothing the filtered data;
S1.4. To ensure the objectivity of test results, dividing the experimental data into a test dataset and a training dataset;
S1.5. Sharding the training dataset by time windows, forming one sample by the data points covered by each time window, and dividing the training dataset into a training set and a validation set with a ratio of 4:1;
S2. Building a deep autoregressive network model based on an attention mechanism (i.e., a TPA-DeepAR model), which comprises the following steps:
S2.1. Adjusting dimension of each sample to (w, 1), and taking the same as an input of the TPA-DeepAR model, wherein w represents the length of a time window;
S2.2. Building an embedding layer, converting dimension of an input sample from (w, 1) to (w, m), wherein m is a designated dimension, and dispersing features of the sample from one dimension to m dimensions;
S2.3. Building an LSTM layer, taking an output of the embedding layer as an input of the LSTM layer, and outputting w hidden neurons {h_{t-w+1}, h_{t-w+2}, . . . , hₜ} by the LSTM layer, with dimension of each hidden neuron being m.
S2.4. Building an attention layer, taking the w hidden neurons {h_{t-w+1}, h_{t-w+2}, . . . , hₜ} output by the LSTM layer as an input of the attention layer, adding weight to relevant dimensions through the attention layer, and finally outputting a hidden neuron [symbol] ;
S2.5. Building a Gaussian layer, wherein the Gaussian layer is composed of two fully connected layers, taking the hidden neuron [symbol] output by the attention layer as an input of the Gaussian layer, and taking outputs of the two fully connected layers of the Gaussian layer as a parameter μ and a parameter σ respectively, therefore a Gaussian distribution will be determined by the outputs of the Gaussian layer, so that the purpose of fitting the Gaussian distribution is achieved by the model;
S2.6. Conducting random sampling for several times by the fitted Gaussian distribution to obtain data of prediction points, and obtaining different quantiles of the prediction points according to sampling points to achieve probability prediction;
S3. Building the attention layer mentioned in S2:
S3.1. The input of the attention layer being the output {h_{t-w+1}, h_{t-w+2}, . . . , hₜ} of the LSTM layer, dimension of input data being (w, m), and using w−1 hidden neurons other than the last hidden neuron hₜ to form a hidden status matrix H={h_{t-w+1}, h_{t-w+2}, . . . , hₜ₋₁};
S3.2. Using k convolution kernels to capture a signal pattern of H and obtain a matrix H^{C}, thus to enhance feature learning ability of the model.
S3.3. Calculating similarity of the hidden neuron hₜ and the matrix H^{C} by a scoring function to obtain an attention weight αᵢ, and using the attention weight αᵢ to conduct weighted summation of each row of H^{C} and obtain a neuron νₜ;
S3.4. Finally, splicing hₜ and νₜ, and inputting one fully connected layer to obtain a new hidden neuron output [symbol] ;
S4. A loss function and an evaluation index of the TPA-DeepAR model:
S4.1. Parameters μ and σ of the predicted Gaussian distribution are output by the TPA-DeepAR model when the model propagates forward; as a traditional loss function used for regression cannot handle relations among μ, σ and y_true (a true label of the samples), the loss function adopted is specifically as follows:

Assuming that the samples obey Gaussian distribution y_true˜(μ, σ²), a likelihood function thereof is:

$$L ( μ , {σ}^{2} ) = {\prod }_{i = 0}^{n} \frac{1}{\sqrt{2 π} σ} {e}^{- \frac{{( y \_ true - μ )}^{2}}{2 {σ}^{2}}}$$

A log-likelihood function thereof is:

$$ln L ( μ , {σ}^{2} ) = - \frac{n}{2} ln ( 2 π ) - \frac{n}{2} ln ( {σ}^{2} ) - \frac{n}{2 {σ}^{2}} {\sum }_{i = 0}^{n} {( y\_true - μ )}^{2}$$

Where, n represents the number of the samples, y_true is known and represents a true label of the samples, μ and σ are the parameters of the Gaussian distribution predicted by the model, and the likelihood function describes the probability of appearing a y_true sample point in the distribution formed by the parameters μ and σ.

Therefore, the network parameters are learned by maximizing the log-likelihood function, i.e., maximizing the probability of the distribution formed by the parameters μ and σ to appear a y_true sample point, and the corresponding loss function of model training can be determined as −lnL(μ, σ²).
S4.2. Based on the loss function, conducting weight updating of the TPA-DeepAR model on the training set obtained in step S1, and finally generating a preliminary prediction model of the model.
S4.3. Using the preliminary prediction model to test on the validation set obtained in step S1 to acquire an F2 evaluation index, adjusting the parameters of the TPA-DeepAR model according to the F2 index, a confusion matrix and an ROC curve to achieve a better result, and saving a TPA-DeepAR prediction model with the best performance of each evaluation index;

Where, the F2 index is:

$$F 2 - score = \frac{2 * P * R}{β * P + R}$$

Where, P is precision, which represents percentage of true positive samples in samples classified as positive:

$$P = \frac{TP}{TP + FP} ;$$

where, TP is a true positive number, FP is a false positive number, and R is recall rate, which represents the percentage of samples that are correctly judged as positive among all the true positive samples:

$$R = \frac{TP}{TP + FN} ;$$

where, FN is a false negative number.

The four indexes TP, FP, TN and FN are presented together in a 2*2 table, then the confusion matrix can be obtained, and the first quadrant to the fourth quadrant of the table are respectively TP, FP, FN and TN. Where, TN is a true negative number.

After the confusion matrix is obtained, the larger the values in the second and fourth quadrants of the matrix, the better; conversely, the smaller the values in the first and third quadrants, the better.

Percentage of samples that are wrongly judged as positive among all the true negative samples is FPR: FPR=FP/(FP+TN). A ROC curve is obtained by taking FPR as the horizontal axis and R as the vertical axis. The closer the ROC curve is to the upper left corner, the higher the recall rate of the TPA-DeepAR model is, the smaller the total number of false positive and false negative numbers is, and the better the prediction effect is.
S5. Using the final TPA-DeepAR prediction model to conduct real-time prediction on the test set:
S5.1. Preprocessing the data of the test set according to the steps of preprocessing, adjusting data dimension of the test set, and inputting the same into a trained TPA-DeepAR model for testing;
S5.2. Giving a predicted surging probability of each sample of the test set by the TPA-DeepAR prediction model in chronological order, and obtaining a real-time surging probability of the samples of the test set.

The present invention has the following beneficial effects:

The prediction method provided by the present invention learns time correlation features of the pressure experiment data of the compressor, captures a small stall inception signal, calculates and outputs the predicted surging probability, and gives a warning signal of whether surging occurs in time. Compared with a traditional method, the prediction method of the present invention uses the attention mechanism to select relevant dimensions for attention weight adding, and can effectively capture the features of the experimental data and accurately predict the surging probability, which improves the stability and accuracy of prediction; at the same time, the method outputs multiple quantiles of the predicted probability, which is convenient for a system to provide early warning according to different quantiles. The method can judge whether surging occurs according to the surging probability output in real time, and provide a feedback to an engine control system in time, so as to adjust the running state of the engine and gain time for a compressor active control method.

### DESCRIPTION OF DRAWINGS

FIG. 1 is a flow chart of a prediction method for stall and surging of an axial-flow compressor based on a deep autoregressive network of an attention mechanism;

FIG. 2 is a flow chart of data preprocessing;

FIG. 3 is a structural diagram of a TPA-DeepAR model;

FIG. 4 is a structural diagram of an attention mechanism; and

FIG. 5 is a diagram showing predicted results of a TPA-DeepAR model on test data, wherein (a) is a diagram showing that dynamic pressure p₂ at a secondary stator tip varies with time, (b) is a diagram showing that predicted surging probability given by the TPA-DeepAR model varies with time, and (c) is a diagram showing an early warning signal given by the TPA-DeepAR model;

### DETAILED DESCRIPTION

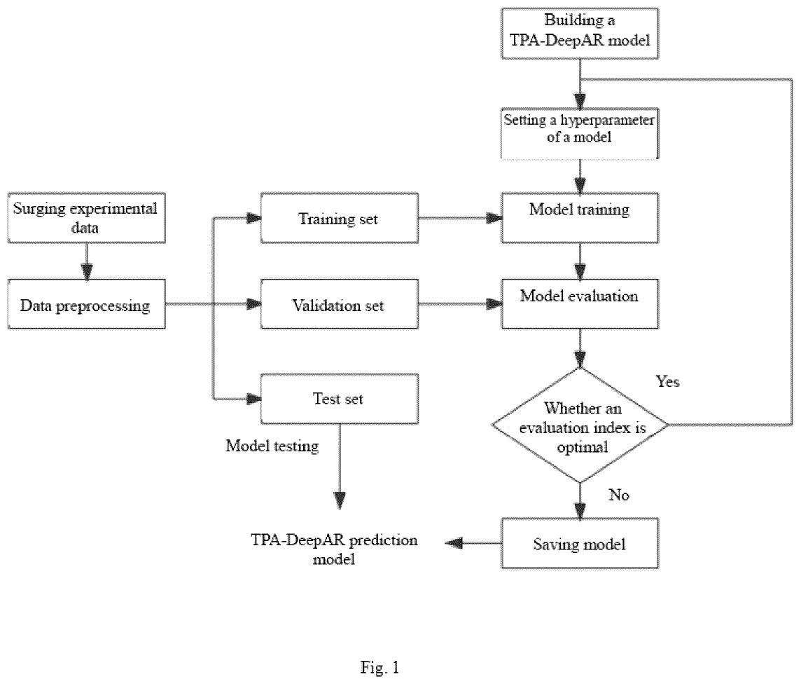

The present invention is further described below in combination with the drawings. The present invention replies on the background of experimental data of surging of a certain type of aero-engine. A flow of a prediction method for stall and surging of an axial-flow compressor based on a deep autoregressive network of an attention mechanism is shown in FIG. 1.

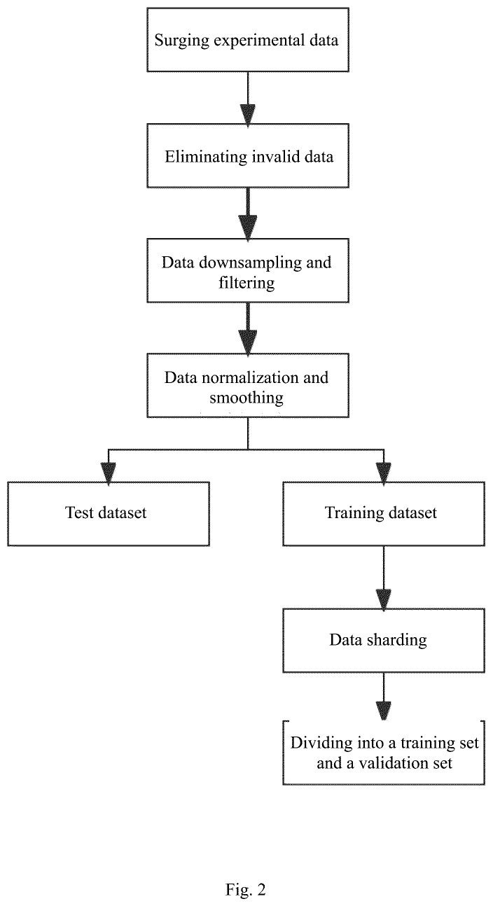

FIG. 2 is a flow chart of data preprocessing, with the data preprocessing steps as follows:
S1. Preprocessing surging data of an aero-engine.
S1.1. Acquiring surging experimental data of a certain type of aero-engine, and eliminating invalid data produced by sensor fault from the experimental data; a total of 16 groups of experimental data are used, each group of experimental data contains dynamic pressure values measured at 10 measure points from normal state to surging state for 10 s, the sensor measurement frequency is 6 kHz, and the 10 measure points are respectively located on an import guide vane stator tip, a zero-level stator tip, a first-stage stator tip (three in circumferential direction), a secondary stator tip, a three-stage stator tip, a four stage stator tip, a five-stage stator tip, and an outlet wall;
S1.2. Downsampling and filtering the remaining valid data in sequence;
S1.3. Normalizing and smoothing the filtered data;
S1.4. To ensure the objectivity of test results, dividing the experimental data into a test dataset and a training dataset;
S1.5. Sharding the training dataset by time windows, forming one sample by the data points covered by each time window, and dividing the training dataset into a training set and a validation set with a ratio of 4:1;

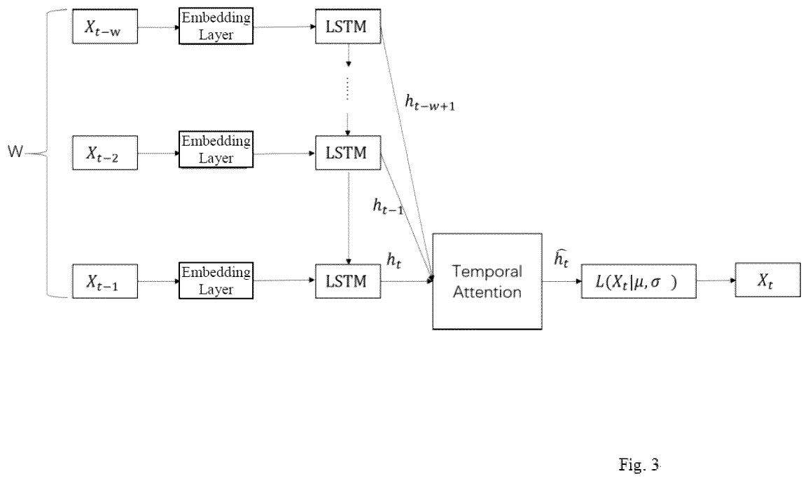

FIG. 3 is a structural diagram of a TPA-DeepAR model.
S2. The steps of building a TPA-DeepAR model are as follows:
S2.1. Adjusting dimension of each sample to (w, 1), and taking the same as an input of the TPA-DeepAR model, wherein w represents the length of a time window;
S2.2. Building an embedding layer, converting dimension of an input sample from (w, 1) to (w, m), wherein m is a designated dimension, and dispersing features of the sample from one dimension to m dimensions;
S2.3. Building an LSTM layer, taking an output of the embedding layer as an input of the LSTM layer, and outputting w hidden neurons {h_{t-w+1}, h_{t-w+2}, . . . , hₜ} by the LSTM layer, with dimension of each hidden neuron being m;
S2.4. Adding an attention layer after the hidden neuron hₜ of the last time step is output, taking the w hidden neurons {h_{t-w+1}, h_{t-w+2}, . . . , hₜ} output by the LSTM layer as an input of the attention layer, adding attention to the m dimensions of the hidden neurons by the attention layer, selecting relevant dimensions to add weight, thus to better capture features of the hidden neurons, and finally outputting a new hidden neuron [symbol] ;
S2.5. Building a Gaussian layer, wherein the Gaussian layer is composed of two fully connected layers, taking the hidden neuron [symbol] as an input of the Gaussian layer, and taking outputs of the two fully connected layers as a parameter μ and a parameter σ respectively, therefore a Gaussian distribution will be determined by the outputs of the Gaussian layer, so that the purpose of fitting the Gaussian distribution is achieved by the model;
S2.6. Conducting random sampling for several times by the fitted Gaussian distribution to obtain data of prediction points, and obtaining different quantiles of the prediction points according to sampling points to achieve probability prediction; the present invention adopts 0.5 quantile of the prediction points as the surging probability output;

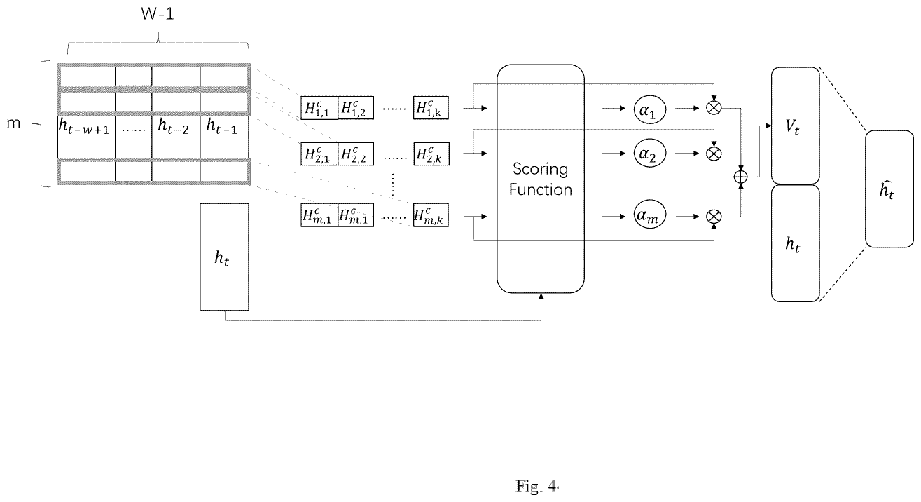

FIG. 4 is a structural diagram of the attention layer.
S3. The steps of building the attention layer are as follows:
S3.1. After an original sequence is processed by the embedding layer and the LSTM layer, obtaining the hidden neurons {h_{t-w+1}, h_{t-w+2}, . . . , hₜ} of each time step of the sample, with dimension of each hidden neuron being m, and using w−1 hidden neurons other than the last hidden neuron hₜ to form a hidden status matrix H={h_{t-w+1}, h_{t-w+2}, . . . , hₜ₋₁};

A row neuron of the hidden status matrix represents the status of a single dimension under all time steps, i.e., a neuron composed of all time steps of the same dimension.

A column neuron of the hidden status matrix represents the status of a single time step, i.e., a neuron composed of all dimensions under the same time step.
S3.2. Using convolution to capture a variable signal pattern and form a matrix H^{C};

$${H}_{i , j}^{C} = {\sum }_{l = 1}^{w - 1} {H}_{i , ( t - w + l )} \times {C}_{j , ( T - w + 1 + l )}$$

Configuring the convolution with k convolution kernels, wherein w is the length of a time window, and each convolution kernel has a size 1×T (T represents an area covered by attention, and T=w−1), calculating the convolution of the convolution kernel along the row neuron of the hidden status matrix H, and extracting a time pattern matrix H_{i,j}^{C} of the variable within the convolution kernel, wherein H_{i,j}^{C} represents a result value of the operation of the i^{th} row neuron and the j^{th} convolution kernel of the matrix H.
S3.3. Calculating similarity of the hidden neuron hₜ and the matrix H^{C} by a scoring function to obtain an attention weight αᵢ, wherein the scoring function selected is:

f(Hᵢ^{C},hᵢ)=(Hᵢ^{C})^{T}Wₐhₜ

Where, Wₐ is a weight.

Using sigmoid for normalization to obtain an attention weight αᵢ for the convenience of selecting multiple dimensions:

αᵢ=sigmoid(f(Hᵢ^{C},hᵢ))

Finally, using the attention weight αᵢ to conduct weighted summation of each row of H_{i,j}^{C} and obtain a neuron νₜ:

$${v}_{t} = {\sum }_{i = 1}^{m} {α}_{i} {H}_{i}^{C}$$

Finally, splicing hₜ and νₜ, and inputting one fully connected layer to obtain a new hidden neuron [symbol] as an output;

[symbol]

=Wₕhₜ+W_{ν}νₜ

Where, Wₕ and W_{ν} are weights.
S4. A loss function and an evaluation index of the TPA-DeepAR model:
S4.1. Parameters μ and σ of the predicted Gaussian distribution are output by the TPA-DeepAR model when the model propagates forward; as a traditional loss function used for regression cannot handle relations among μ, 94 and y_true (a true label of the samples), the loss function adopted is specifically as follows:

Assuming that the samples obey Gaussian distribution y_true˜(μ, σ²), a likelihood function thereof is:

$$L ( μ , {σ}^{2} ) = {\prod }_{i = 0}^{n} \frac{1}{\sqrt{2 π} σ} {e}^{- \frac{{( y \_ true - μ )}^{2}}{2 {σ}^{2}}}$$

A log-likelihood function thereof is:

$$ln L ( μ , {σ}^{2} ) = - \frac{n}{2} ln ( 2 π ) - \frac{n}{2} ln ( {σ}^{2} ) - \frac{n}{2 {σ}^{2}} {\sum }_{i = 0}^{n} {( y\_true - μ )}^{2}$$

Where, n represents the number of the samples, y_true is known and represents a true label of the samples, μ and σ are the parameters of the Gaussian distribution predicted by the model, and the likelihood function describes the probability of appearing a y_true sample point in the distribution formed by the parameters μ and σ.

Therefore, the network parameters are learned by maximizing the log-likelihood function, i.e., maximizing the probability of the distribution formed by the parameters μ and σ to appear a y_true sample point, and the corresponding loss function of model training can be determined as −lnL(μ, σ²).
S4.2. Based on the loss function, conducting weight updating of the TPA-DeepAR model on the training set obtained in step S1, and finally generating a preliminary prediction model of the model.
S4.3. Using the preliminary prediction model to test on the validation set obtained in step S1 to acquire an F2 evaluation index, adjusting the parameters of the TPA-DeepAR model according to the F2 index, a confusion matrix and an ROC curve to achieve a better result, and saving a TPA-DeepAR prediction model with the best performance of each evaluation index;

Where, the F2 index is:

$$F 2 - score = \frac{2 * P * R}{β * P + R}$$

Where, P is precision, which represents percentage of true positive samples in samples classified as positive:

$$P = \frac{TP}{TP + FP} ;$$

where, TP is a true positive number, FP is a false positive number, and R is recall rate, which represents the percentage of samples that are correctly judged as positive among all the true positive samples:

$$R = \frac{TP}{TP + FN} ;$$

where, FN is a false negative number.

The four indexes TP, FP, TN and FN are presented together in a 2*2 table, then the confusion matrix can be obtained, and the first quadrant to the fourth quadrant of the table are respectively TP, FP, FN and TN.

Where, TN is a true negative number. After the confusion matrix is obtained, the larger the values in the second and fourth quadrants of the matrix, the better; conversely, the smaller the values in the first and third quadrants, the better.

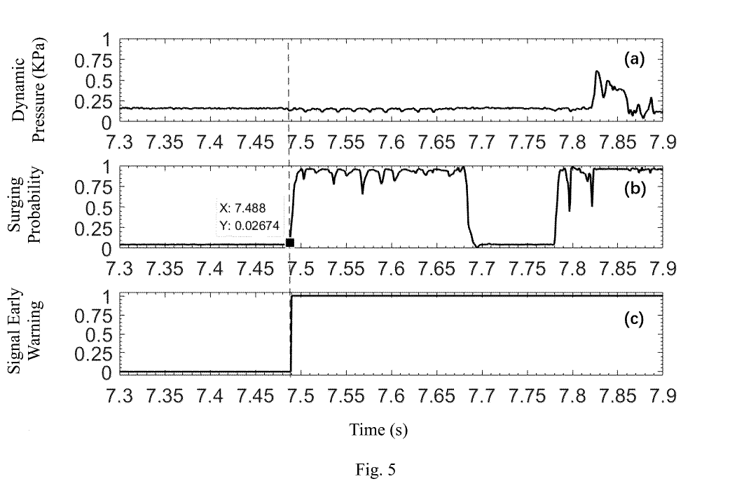

Percentage of samples that are wrongly judged as positive among all the true negative samples is FPR: FPR=FP/(FP+TN). A ROC curve is obtained by taking FPR as the horizontal axis and R as the vertical axis. The closer the ROC curve is to the upper left corner, the higher the recall rate of the TPA-DeepAR model is, the smaller the total number of false positive and false negative numbers is, and the better the prediction effect is.
S5. Using the final TPA-DeepAR prediction model to conduct real-time prediction on the test set; FIG. 5 is a diagram showing predicted results of the TPA-DeepAR prediction model on test data, wherein (a) is a diagram showing that dynamic pressure p₂ at a secondary stator tip varies with time, (b) is a diagram showing that predicted surging probability given by the TPA-DeepAR prediction model varies with time, and (c) is a diagram showing an early warning signal given by the TPA-DeepAR prediction model according to the predicted probability. The steps of conducting real-time prediction on test data are as follows:
S5.1. Preprocessing the data of the test set according to the steps of preprocessing, adjusting data dimension of the test set, and inputting the same into a trained TPA-DeepAR model; the data of the test set is the dynamic pressure data at the position of the secondary stator tip, and it can be seen from diagram (a) that a spike-type stall inception developing downward appears at 7.48 s at the initial disturbance stage of stall; with the development of disturbance of stall, a violent fluctuation appears at 7.826 s, which is thoroughly developed into stall and surging.
S5.2. Giving a predicted surging probability of each group of data of the test set by the TPA-DeepAR prediction model in chronological order; by observing diagram (b), it can be seen that the curve of the predicted probability has an initial disturbance around 7.488 s, and the surging probability increases rapidly and then maintains at a relatively high level; the original dynamic pressure data restores to a stable state around 7.68 s, and the curve of the surging probability falls rapidly and then rises again with the fluctuation of the original dynamic pressure data. When the initial disturbance occurs, rotating stall and surging will occur with a high probability, which will have a very serious impact. Therefore, a threshold value is set for the prediction curve of surging probability. When the threshold is exceeded, an early warning signal is given to achieve early warning at the initial disturbance stage. Therefore, the TPA-DeepAR prediction model can make a response to the small changes at the initial disturbance stage in time, and output the value of the surging probability according to the development of the disturbance.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A prediction method for stall and surging of an axial-flow compressor based on a deep autoregressive network, comprising the following steps:
S1. preprocessing surging data of an aero-engine, dividing experimental data into a test dataset and a training dataset, and then dividing the training dataset proportionally into a training set and a validation set;
S2. building a deep autoregressive network model based on an attention mechanism (i.e., a TPA-DeepAR model), which comprises the following steps:
S2.1. adjusting dimension of each sample to (w, 1), and taking the same as an input of the TPA-DeepAR model, wherein w represents the length of a time window;
S2.2. building an embedding layer, converting dimension of an input sample from (w, 1) to (w, m), wherein m is a designated dimension, and dispersing features of the sample from one dimension to m dimensions;
S2.3. building an LSTM layer, taking an output of the embedding layer as an input of the LSTM layer, and outputting w hidden neurons {h_{t-w+1}, h_{t-w+2}, . . . , hₜ} by the LSTM layer, with dimension of each hidden neuron being m;
S2.4. building an attention layer, taking the w hidden neurons {h_{t-w+1}, h_{t-w+2}, . . . , hₜ} output by the LSTM layer as an input of the attention layer, adding weight to relevant dimensions through the attention layer, and finally outputting a hidden neuron [symbol] ;
S2.5. building a Gaussian layer, wherein the Gaussian layer is composed of two fully connected layers, taking the hidden neuron [symbol] output by the attention layer as an input of the Gaussian layer, and taking outputs of the two fully connected layers of the Gaussian layer as a parameter μ and a parameter σ respectively, therefore a Gaussian distribution will be determined by the outputs of the Gaussian layer, so that the purpose of fitting the Gaussian distribution can be achieved by the model;
S2.6. conducting random sampling for several times by the fitted Gaussian distribution to obtain data of prediction points, and obtaining different quantiles of the prediction points according to sampling points to achieve probability prediction;
S3. building the attention layer mentioned in S2:
S3.1. the input of the attention layer being the output {h_{t-w+1}, h_{t-w+2}, . . . , hₜ} of the LSTM layer, dimension of input data being (w, m), and using w−1 hidden neurons other than the last hidden neuron hₜ to form a hidden status matrix H={h_{t-w+1}, h_{t-w+2}, . . . , hₜ₋₁};
S3.2. using k convolution kernels to capture a signal pattern of H and obtain a matrix H^{C}, thus to enhance feature learning ability of the model;
S3.3. calculating similarity of the hidden neuron hₜ and the matrix H^{C} by a scoring function to obtain an attention weight αₜ, and using the attention weight αᵢ to conduct weighted summation of each row of H^{C} and obtain a neuron νₜ;
S3.4. finally, splicing hₜ and νₜ, and inputting one fully connected layer to obtain a new hidden neuron output [symbol] ;
S4. a loss function and an evaluation index of the TPA-DeepAR model:
S4.1. parameters μ and σ of the predicted Gaussian distribution are output by the TPA-DeepAR model when the model propagates forward, and the loss function adopted is specifically as follows:
assuming that the samples obey Gaussian distribution y_true˜(μ, σ²), a likelihood function thereof is:
$$L ( μ , {σ}^{2} ) = {\prod }_{i = 0}^{n} \frac{1}{\sqrt{2 π} σ} {e}^{- \frac{{( y \_ true - μ )}^{2}}{2 {σ}^{2}}}$$
a log-likelihood function thereof is:
$$ln L ( μ , {σ}^{2} ) = - \frac{n}{2} ln ( 2 π ) - \frac{n}{2} ln ( {σ}^{2} ) - \frac{n}{2 {σ}^{2}} {\sum }_{i = 0}^{n} {( y\_true - μ )}^{2}$$
where, n represents the number of the samples, y_true is known and represents a true label of the samples, μ and σ are the parameters of the Gaussian distribution predicted by the model, and the likelihood function describes the probability of appearing a y_true sample point in the distribution formed by the parameters μ and σ;
therefore, the network parameters are learned by maximizing the log-likelihood function, i.e., maximizing the probability of the distribution formed by the parameters μ and σ to appear a y_true sample point, and the corresponding loss function of model training can be determined as −lnL(ρ, σ²);
S4.2. based on the loss function, conducting weight updating of the TPA-DeepAR model on the training set obtained in step S1, and finally generating a preliminary prediction model of the model;
S4.3. using the preliminary prediction model to test on the validation set obtained in step S1 to acquire an F2 evaluation index, adjusting the parameters of the TPA-DeepAR model according to the F2 index, a confusion matrix and an ROC curve to achieve a better result, and saving a TPA-DeepAR prediction model with the best performance of each evaluation index;
S5. using the final TPA-DeepAR prediction model to conduct real-time prediction on the test set:
S5.1. preprocessing the data of the test set according to the steps of preprocessing, adjusting data dimension of the test set, and inputting the same into a trained TPA-DeepAR model for testing;
S5.2. giving a predicted surging probability of each sample of the test set by the TPA-DeepAR prediction model in chronological order, and obtaining a real-time surging probability of the samples of the test set.

2. The prediction method for stall and surging of an axial-flow compressor based on a deep autoregressive network according to claim 1, wherein in step S1, “preprocessing surging data of an aero-engine” is specifically as follows:
S1.1. acquiring surging experimental data of a certain type of aero-engine, and eliminating invalid data produced by sensor fault from the experimental data;
S1.2. downsampling and filtering the remaining valid data in sequence;
S1.3. normalizing and smoothing the filtered data;
S1.4. to ensure the objectivity of test results, dividing the experimental data into a test dataset and a training dataset;
S1.5. sharding the training dataset by time windows, forming one sample by the data points covered by each time window, and dividing the training dataset into a training set and a validation set with a ratio of 4:1.

3. The prediction method for stall and surging of an axial-flow compressor based on a deep autoregressive network according to claim 2, wherein in step S4.3:
the F2 index is:
$$F 2 - score = \frac{2 * P * R}{β * P + R}$$
where, P is precision, which represents percentage of true positive samples in samples classified as positive:
$$P = \frac{TP}{TP + FP} ;$$
where, TP is a true positive number, FP is a false positive number, and R is recall rate, which represents the percentage of samples that are correctly judged as positive among all the true positive samples:
$$R = \frac{TP}{TP + FN} ;$$
where, FN is a false negative number;
the four indexes TP, FP, TN and FN are presented together in a 2*2 table, then the confusion matrix can be obtained, and the first quadrant to the fourth quadrant of the table are respectively TP, FP, FN and TN; where, TN is a true negative number;
after the confusion matrix is obtained, the larger the values in the second and fourth quadrants of the matrix, the better; conversely, the smaller the values in the first and third quadrants, the better;
percentage of samples that are wrongly judged as positive among all the true negative samples is FPR: FPR=FP/(FP+TN); a ROC curve is obtained by taking FPR as the horizontal axis and R as the vertical axis; the closer the ROC curve is to the upper left corner, the higher the recall rate of the TPA-DeepAR model is, the smaller the total number of false positive and false negative numbers is, and the better the prediction effect is.
